(19) United States
(12) Patent Application Publication
(10) Pub. No.: US 2009/0050492 A1
(43) Pub. Date: Feb. 26, 2009

(54) Nanoporous silicon-based electrochemical nucleic acid biosensor

(75) Inventors: Evangelyn C. Alocilja, East Lansing, MI (US); Finny P. Mathew, Okemos, MI (US)

Correspondence Address: Ian C. McLeod;IAN C. McLEOD, P.C., 2190 Commons Parkway, Okemos, MI, 48864, US

(73) Assignee: Board of Trustees of Michigan State University, East Lansing, MI (US)

(21) Appl. No.: 12/214,474

(22) Filed: Jun. 19, 2008

Related U.S. Application Data
(63) Continuation-in-part of application No. 11/496,648, filed on Jul. 31, 2006.
(60) Provisional application No. 60/704,550, filed on Aug. 2, 2005.

(51) Int. Cl. G01N 27/26

(52) U.S. Cl. 205/782; 204/403.01

(57) ABSTRACT

A method and biosensor device for detecting single strand target nucleic acid by cyclic voltammetry is described. A porous silicon chip is linked to bound DNA probe complementary to the target nucleic acid. The device is particularly useful for detecting microorganisms and viruses that may be pathogenic or cancer genes, however any target nucleic acid can be detected by using a specific DNA probe.

### CROSS-REFERENCE TO RELATED APPLICATIONS

This application is a continuation-in-part of U.S. patent application Ser. No. 11/496,648 to Alocilja and Mathew, filed Jul. 31, 2006, which claims priority to Provisional Application Ser. No. 60/704,550, filed Aug. 2, 2005, which is incorporated herein by reference in its entirety.

### STATEMENT REGARDING FEDERALLY SPONSORED RESEARCH OR DEVELOPMENT

Not Applicable

### STATEMENT REGARDING GOVERNMENT RIGHTS

Not Applicable

### BACKGROUND OF THE INVENTION

(1) Field of the Invention

The present invention relates to a nanoporous silicon based electrochemical nucleic acid biosensor. In particular, the present invention provides a single strand segment of DNA binding pair member immobilized on the porous silicon material which binds to a single strand nucleic acid from a sample. The conductance is changed by the binding and can be detected in an electrochemical cell by cyclic voltammetry.

(2) Description of the Related Art

Over two hundred diseases are known to be transmitted through food, and these are caused by forty different foodborne disease causing organisms (pathogens), including fungi, viruses and bacteria (Mead et al., Food-related illness and death in the United States. Emerging Infectious Diseases 5(5), 607-625, 1999). The Centers for Disease Control and Prevention (CDC) reports estimate that foodborne diseases cause approximately 76 million illnesses, including 325,000 hospitalizations and 5000 deaths in the US each year (Mead et al., ibid, 1999). The estimated annual cost of human illness caused by a group of seven pathogens (including six bacteria namely: Salmonella, Listeria, Campylobacter, Escherichia coli O157:H7, Staphylococcus aureus, and Clostridium perfringens) commonly associated with foodborne outbreaks is $5.6-9.4 billion annually (Buzby et al., Bacterial Foodborne Disease: Medical Costs and Productivity Losses. Economic Research Service, U.S. Department of Agriculture, 1999). A rapid and sensitive primary screening method with proper sampling plan is required too detect these foodborne pathogens. The current invention is focused on developing a rapid detection method using a nanoporous silicon-based biosensor with label-free electrochemical detection of target nucleic acid. In one embodiment, the target nucleic acid is bacterial DNA, including DNA from pathogenic bacteria.

The method currently in use for bacterial pathogen identification is to culture the bacteria from food samples, a time-consuming and laborious process. The conventional procedure of pre-enrichment broth, selective enrichment broth and differential agar requires 2-7 days (sometimes as long as 7-10 days) to achieve a confirmed identification of the target pathogen (Food and Drug Administration, Bacteriological Analytical Manual, 8^{th} ed. Association of Analytical Chemists, Arlington, Va., 2000).

The inventors have described an enzyme assay using a porous silicon substrate in Biosensors and Bioelectronics, 20: 1656-1661 (2005). The detection was by light emission. There was a need for improved sensitivity. This publication is incorporated by reference herein in relation to the formation of the porous silicon material.

U.S. Pat. No. 6,884,290 B2 to Swain et al. describes an improved type of diamond electrode for cyclic voltammetry. Swain et al. is cited as general prior art.

### OBJECTS

It is an object of the present invention to provide an electrochemical biosensor which detects target nucleic acid. It is also an object of the present invention to provide an assay which is sensitive and reliable. These and other objects will become increasingly apparent by reference to the following description and the drawings.

### BRIEF DESCRIPTION OF DRAWINGS

FIG. 1A is a schematic drawing of one embodiment of a silicon DNA chip for a biosensor device of the present invention. FIG. 1B shows a removable cartridge with a silicon DNA chip as seen in FIG. 1A in a handheld portable biosensor unit for detecting the DNA.

FIG. 2 is a cross-sectional view of a single-tank cell 110 used for porous silicon chip fabrication by etching.

FIG. 3 shows a chemical process scheme for functionalization of planar silicon and nano-tubular silicon as platforms for a DNA-based biosensor.

FIG. 4 is a schematic of a scheme for target DNA hybridization to an immobilized DNA probe on a functionalized biosensor surface.

FIG. 5 is a schematic view of a three-electrode electrochemical cell 210 configuration used for cyclic voltammetry measurements.

FIG. 6 is a cross-sectional SEM image of nano-porous Si produced from p⁺⁺ type Si. Anodizing conditions used were 15% HF, 5 mA/cm² for 1 h. NPS chip cross-section was placed at 45° to capture the image.

FIG. 7 shows gel electrophoresis of PCR-amplified Salmonella and extracted E. coli DNA. S1 to S5-1 to 5 μl Salmonella-E. coli (1:1) culture mix used for PCR. Key: M—Marker, C—negative control, S—Salmonella-E. coli, EC—E. coli.

FIG. 8 shows AFM images of NPS biosensor chip: (FIG. 8A) Before DNA probe immobilization; (FIG. 8B) After probe immobilization; (FIG. 8C) After target DNA hybridization.

FIG. 9 shows cyclic voltammograms for: (FIG. 9A) PCR-amplified S. Enteritidis DNA, (FIG. 9B) Isolated S. Enteritidis genomic DNA obtained with NPS biosensor; and (FIG. 9C) PCR-amplified S. Enteritidis DNA, (FIG. 9D) Isolated S. Enteritidis genomic DNA obtained with planar Si biosensor.

FIG. 10 shows cyclic voltammograms for S. Enteritidis (target) DNA, E. coli (non-target) DNA, and a 1:1 mixture of S. Enteritidis and E. coli DNA obtained with the NPS biosensor (specificity testing).

### SUMMARY OF THE INVENTION

The present invention provides a biosensor device for detecting the presence of a target nucleic acid in a sample comprising: a porous silicon material; a single-stranded DNA probe covalently attached to the porous silicon material, wherein the probe comprises a DNA sequence complementary to a sequence of the target nucleic acid; and an electrochemical apparatus supporting the porous silicon material for detecting the presence or absence of any target nucleic acid bound to the DNA probe that is covalently attached to the porous silicon material by measuring conductance. In further embodiments, the electrochemical apparatus is a potentiostat/galvanostat. In still further embodiments, the electrochemical apparatus measures capacitance or resistance to determine the conductance. In still further embodiments, the target nucleic acid is a DNA molecule. In further embodiments, the target nucleic acid is a DNA molecule from a microorganism or a virus. In still further embodiments, the microorganism is selected from the group consisting of Salmonella, Listeria, Campylobacter, Escherichia coli O157:H7, Staphylococcus aureus, and Clostridium perfringens. In still further embodiments, the target nucleic acid is a DNA molecule from a eukaryote selected from the group consisting of protists, plants, fungi, and animals. In further embodiments, the target nucleic acid is a DNA molecule from a human. In still further embodiments, the target nucleic acid is an RNA molecule.

The present invention provides a method for detecting a target nucleic acid in a sample comprising: providing the sample; providing a biosensor device for detecting the presence of the target nucleic acid in the sample comprising a porous silicon material, a single-stranded DNA probe covalently attached to the porous silicon material, wherein the probe comprises a DNA sequence complementary to a sequence of the target nucleic acid, and an electrochemical apparatus supporting the porous silicon material for detecting the presence or absence of any target nucleic acid bound to the DNA probe covalently attached to the porous silicon material by measuring conductance; contacting the porous silicon material to a solution comprising the sample under conditions such that the target nucleic acid, if present, binds to the DNA probe to provide a binding pair on the porous silicon material; inserting the porous silicon material with or without the target nucleic acid into the electrochemical apparatus for detecting the presence or absence of the target nucleic acid by measuring conductance; and detecting the presence or absence of the target nucleic acid by measuring conductance in the apparatus.

In further embodiments, the electrochemical apparatus is a potentiostat/galvanostat and the target nucleic acid is detected by means of cyclic voltammetry. In further embodiments, the sample is from a patient and the target nucleic acid is a cancer diagnostic gene, and the method further comprises the step of (f) diagnosing whether the patient has a cancer after detecting the presence or absence of the target nucleic acid in step (e).

In further embodiments, the sample is from a patient and the target—nucleic acid is a DNA molecule from a microorganism or virus, and the method further comprises the step of (f) diagnosing whether the patient is infected with the microorganism or virus after detecting the presence or absence of the target nucleic acid in step (e).

In still further embodiments, the patient is a human. In further embodiments, the target nucleic acid is a DNA molecule from a microorganism or virus, and the method further comprises the step of (f) determining whether a location from which the sample is taken is contaminated with the microorganism or virus after detecting the presence or absence of the target nucleic acid in step (e).

The present invention provides a method for detecting a target nucleic acid in a sample comprising: providing the sample; providing a biosensor device for detecting the presence of the target nucleic acid in the sample comprising a porous silicon material, a single-stranded DNA probe covalently attached to the porous silicon material, wherein the probe comprises a DNA sequence complementary to a sequence of the target nucleic acid, and an electrochemical apparatus supporting the porous silicon material for detecting the presence or absence of any target nucleic acid bound to the DNA probe covalently attached to the porous silicon material by measuring conductance; contacting the porous silicon material to a solution comprising the sample under conditions such that the target nucleic acid, if present, binds to the DNA probe to provide a hybridized binding pair on the porous silicon material; inserting the porous silicon material with or without the target nucleic acid into the electrochemical apparatus for detecting the presence or absence of the target nucleic acid by measuring a cumulative charge value (AQ); and detecting the presence or absence of the target nucleic acid by measuring the cumulative charge value (AQ) in the apparatus. In further embodiments, the sample is from a patient and the target nucleic acid is a cancer diagnostic gene, and the method further comprises the step of (f) diagnosing whether the patient has a cancer after detecting the presence or absence of the target nucleic acid in step (e). In further embodiments, the sample is from a patient and the target nucleic acid is a DNA molecule from a microorganism or virus, and the method further comprises the step of (f) diagnosing whether the patient is infected with the microorganism or virus after detecting the presence or absence of the target nucleic acid in step (e). In still further embodiments, the patient is a human. In further embodiments, the target nucleic acid is a DNA molecule from a microorganism or virus, the method further comprises the step of (f) determining whether a location from which the sample is taken is contaminated with the microorganism or virus after detecting the presence or absence of the target nucleic acid in step (e).

The substance and advantages of the present invention will become increasingly apparent by reference to the following drawings and the description.

### DESCRIPTION OF THE PREFERRED EMBODIMENTS

All patents, patent applications, government publications, government regulations, and literature references cited in this specification are hereby incorporated herein by reference in their entirety. In case of conflict, the present description, including definitions, will control.

While several biosensors are being developed for rapid detection of target nucleic acid, such as pathogenic bacteria, very few biosensors are commercially available. With the recent advances in the silicon-based IC industry, biosensors using a silicon-based platform would be more amenable to commercialization using existing microfabrication processes. The present invention provides a porous silicon-based biosensor. Nanoporous silicon has advantages over planar platforms in biosensor development due to the increased surface area, which will allow for higher sensitivity while using a smaller device. Porous silicon can be easily synthesized directly from the same single-crystal silicon wafers used in the microelectronics industry, making it ideal for a silicon-based technology. A porous silicon-based device is compatible with established solid-state fabrication technologies. The invention can be used by the food industry for quality assurance, hospitals and primary care facilities for diagnosis of primary or nosocomial infections, epidemiologists for identification of a foodborne epidemic etiology (source and/or cause), and rapid response teams in bioterrorism events. Other uses including detection of target nucleic acid for the diagnosis of cancers, and to detect viruses (such as HIV or hepatitis viruses, etc.) are encompassed by the present invention. Any use requiring the specific detection of a target nucleic acid is envisioned for the present invention.

U.S. patent application Ser. No. 11/402,034 to Alocilja, hereby incorporated herein by reference in its entirety, describes a biosensor device for detecting DNA of a microorganism. The present invention provides a nanoporous silicon-based electrochemical nucleic acid biosensor. The present invention provides a biosensor device for detecting a target nucleic acid which comprises a porous silicon material coated with one part of a binding pair which is a complementary single stranded DNA for binding a target single-stranded nucleic acid from a sample which enables the detection of a microorganism, typically pathogenic bacteria, viruses, etc. Alternatively, the device can be used to detect a nucleic acid from a cancer, etc. for diagnostic purposes. The biosensor device has an electrochemical device supporting the porous silicon material for detecting the presence or absence of the binding pair by measuring conductance.

The phrase “DNA probe” refers to any single-stranded DNA having a nucleic acid sequence, at least a portion of which is complementary to a nucleic acid sequence of a target nucleic acid to be detected by the biosensor device. In some embodiments, the single-stranded DNA is a synthetic oligonucleotide, however any single-stranded DNA can be used. It is to be understood that DNA probes can be designed by a person of skill in the art so as to be complimentary to any known target nucleic acid sequence of interest. Any DNA probe can be used that will hybridize to the target nucleic acid under the conditions used.

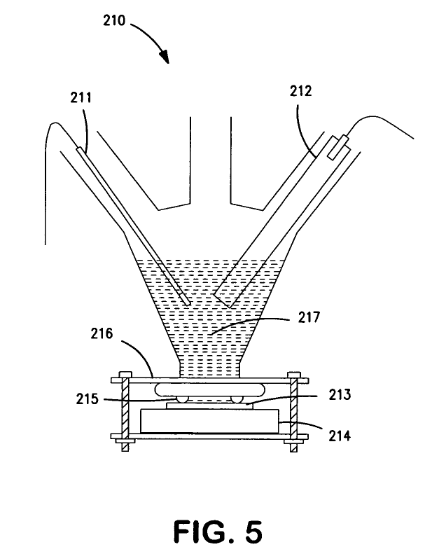

The term “electrochemical apparatus” as used herein refers to any device for electrochemical detection. In some embodiments, the electrochemical apparatus can be provided as illustrated in FIG. 5 as described below. In other embodiments, the electrochemical detection can alternatively be done in a handheld portable biosensor unit as the electrochemical apparatus. The electrochemical apparatus can be, but is not limited to, a device as commercially available from Uniscan Instruments (Uniscan Instruments Ltd, Buxton, United Kingdom). One example of data acquisition circuitry that is provided as a handheld potentiostat/galvanostat is model PG580 potentiostat/galvanostat from Uniscan Instruments. The Generic Base Sensor from Uniscan Instruments can be modified to provide the three electrode electrochemical sensor based on screen printed electrode technology. The Generic Base Sensor provides a carbon working electrode, Ag/AgCl reference electrode, and a counter electrode. The base carbon electrode of the Generic Base Sensor can be connected to the porous silicon working electrode of the present invention to provide the handheld biosensor unit.

The term “microorganism” as used herein refers to any microscopic organism, including unicellular or multicellular organisms. The term “microorganism” includes, but is not limited to bacteria.

The term “porous silicon material” as used herein refers to any porous silicon including, but not limited to, the nano-tubular silicon chip platform fabricated using the anodization process described herein. The term “DNA chip” as used herein refers to the silicon material having one part of a binding pair which is a complementary single-stranded DNA attached to the silicon material.

The term “target nucleic acid” as used herein encompasses any known nucleic acid, including DNA or RNA. In some embodiments, the target nucleic acid is from a microorganism or a virus. Examples of microorganisms that can be detected include, but are not limited to, Salmonella, Listeria, Campylobacter, Escherichia coli O157:H7, Staphylococcus aureus, and Clostridium perfringens. In some embodiments, the target nucleic acid is from a eukaryote including any protist, plant, fungus, or animal. In some embodiments, the target nucleic acid is from a pathogenic organism. However in other embodiments the target nucleic acid is a gene or a mRNA in a human or animal patient. The target nucleic acid can be a DNA molecule in a sample obtained from a human that is indicative of a disease state, such as a cancer. In some embodiments, the target nucleic acid can also be from a virus, such as HIV or hepatitis A, B, or C.

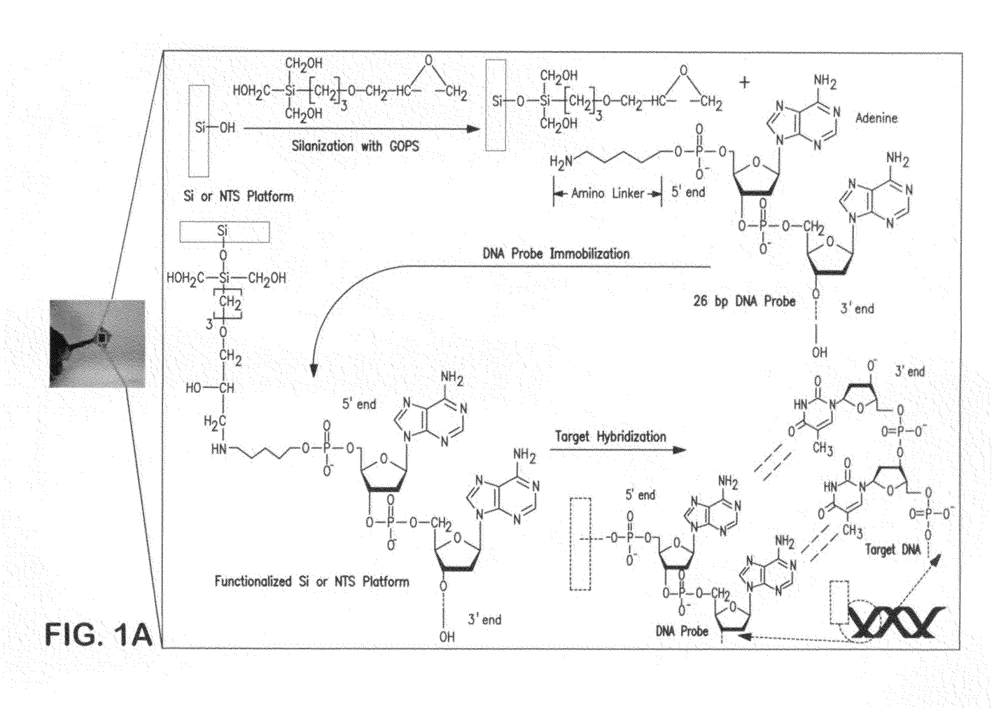

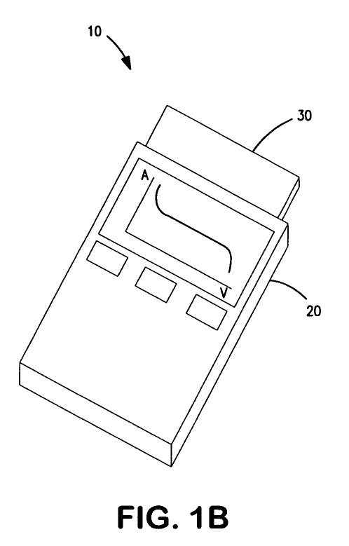

Design, fabrication and characterization of a nano-tubular silicon platform: The prototype biosensor of this embodiment was designed keeping in mind the long-term goal of building a self-contained nucleic acid-based individually addressable portable biosensor. In this embodiment, the process of PCR for DNA amplification was performed externally. The amplified product was then introduced to the prototype biosensor DNA chip illustrated in FIG. 1A. The biosensor was fabricated on a p⁺⁺-type silicon 4 inch wafer with final chip dimensions of 1.5 cm×1.5 cm. The main fabrication steps are described below. As illustrated in FIG. 1B, a handheld portable biosensor unit 10 can be provided that incorporates data acquisition circuitry in a portable electrochemical device 20 supporting the porous silicon material as a DNA chip in a removable cartridge 30. The portable electrochemical device 20 can be used to detect the presence or absence of the binding pair.

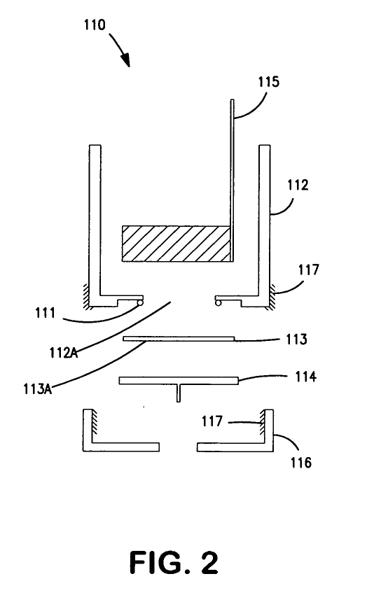

Nano-tubular silicon fabrication: Nano-tubular silicon as the porous silicon material was fabricated using the anodization process in a conventional single-tank cell 110, illustrated in FIG. 2. An O-ring 111 was placed around the bottom hole 112A of the inverted TEFLON® polytetrafluoroethylene (PTFE) (DuPont, Wilmington, Del.) cell 112. The silicon wafer 113 was then placed over the O-ring 111. Before the copper plate 14 was placed over the silicon wafer 113, the back surface 113A of the silicon wafer 113 was scratched with a diamond-tipped scribe (not shown) followed by application of graphite coating using a graphite pen (not shown) to make the silicon wafer 113 more conductive. The copper plate 114 metal contact was then mated to the back surface 13A of the silicon wafer 113 and sealed with a cap 116. The cap 116 is screwed onto the cell 112 by means of threaded portions 117 on the cap 116 and the cell 112. A platinum grid 115 (or wire) placed inside the TEFLON® cell 112 served as the cathode and the copper plate 114 as the anode. The platinum grid 115 (or wire) and the copper plate 114 were connected to the negative and positive terminal (not shown) of a power supply, respectively. After placing the TEFLON® cell 112 upright, 15% hydrofluoric acid in ethanol was poured into the TEFLON® cell 112. The silicon wafer 113 was then electrochemically etched in the 15% hydrofluoric solution using different current and time conditions as follows: a) 100 mA—30 sec, b) 50 mA—1 min, c) 30 mA—1 min, d) 15 mA—1 min, e) 5 mA—20 min, f) 5 mA—1 hr, and g) 2 mA—1 hr. These current-time conditions were chosen by modifying those used for porous silicon fabrication (Halimaoui, A. 1997. Porous silicon formation by anodization. In Properties of porous silicon, 12-14. L. Canham, ed. London, UK: INSPEC, The Institution of Electrical Engineers) so as to obtain the desired nano-tubular silicon (Si) platform.

Characterization of nano-tubular silicon: SEM image of all nano-tubular silicon chips were taken using a Hitachi S-4700 II Field Emission Scanning Electron Microscope to evaluate the quality of nano-porous silicon chips obtained. Images were used to observe the size and shape of the tubes, inter-tube space, surface texture, and thickness of the nano-tubular layer obtained under different anodization conditions described above and to determine the best conditions of anodization.

The porosity and thickness of the porous silicon layers were also determined. The porosity was determined by weight measurements. The virgin wafer chip was first weighed before anodization (m₁), then just after anodization etching (m₂) and finally after complete dissolution of the nano-tubular Si layer in NaOH solution (m₃). The porosity is given by the following equation:

$$P ( \% ) = \frac{( {m}_{1} - {m}_{2} )}{( {m}_{1} - {m}_{3} )} \times 100 \qquad Equation 1$$

From the above measurements, the thickness of the porous silicon layer was also determined from Equation 2 as follows:

$$W = \frac{( {m}_{1} - {m}_{3} )}{S \times d} ; \qquad Equation 2$$

where,

d is the bulk silicon density, (2.33 g/cm³), and

S is the area of the wafer exposed to HF during anodization (circular area of 1.1 cm diameter=0.95 cm²).

The final dissolution process was carried out in the TEFLON® cell used for anodization. The chip, after weighing (m₂), was carefully placed under the cell (as described above) and exposed to an aqueous solution of 2.5 M NaOH for a period ranging between thirty to ninety (30-90) minutes (Vázsonyi, É., Z. Vértesy, A. Tóth, and J. Szlufcik (2003), Anisotropic etching of silicon in a two-component alkaline solution, Journal of Micromechanics and Microengineering 13(1): 165-169) until the shiny clear surface of planar silicon was visible again. The chip was then weighed again (m₃).

I. Functionalization of the nano-tubular silicon platform as the porous silicon material with Salmonella DNA probes into a nucleic acid-based biosensor.

Bacterial strains: A clinical strain of Salmonella enteritidis (strain S-64) was obtained from the Michigan Department of Community Health (Lansing, Mich.) and stored at −70° C. The pathogen was grown on trypticase soy agar containing 0.6% yeast extract (TSAYE) and/or broth (TSBYE) at 37° C., as appropriate. In broth culture, cells were grown to exponential phase, and enumerated by spiral plating appropriately diluted cultures on Bismuth Sulfite Agar and Brilliant Green Agar. The cultures were serially diluted for DNA extraction so that the number of bacterial cells ranged from 10⁰ to 10⁸ CFU/ml.

DNA Primers and Probes: Primers used for PCR were designed for the detection of Salmonella enteritidis from the insertion element (Iel) gene (Wang, S. J., and D. B. Yeh (2002) Designing of polymerase chain reaction primers for the detection of Salmonella enteritidis in foods and faecal samples, Lett Appl Microbiol 34(6): 422-427). The single stranded forward and reverse primers were IelL: 5′-CTAACAGGCGCATACGATCTGACA-3′ (SEQ ID NO: 1) (positions 542 to 565, 24 bases) and IelR: 5′-TACGCATAGCGATCTCCTTCGTTG-3′ (SEQ ID NO: 2) (positions 1047 to 1024, 24 bases). Capture probe used was 5′-(Amino link)-AATATGCTGCCTACTGCCCTACGCTT-3′ (SEQ ID NO: 3) (positions 690 to 716 of target, 26 bases).

Polymerase Chain Reaction (PCR): Polymerase chain reaction was performed with Taq DNA polymerase in a DNA thermal cycler. Promega Master Mix (Promega Corporation, Madison, Wis.), containing the proprietary reaction buffer (pH 8.5), 200 μM deoxynucleotide triphosphates (dNTPs), 0.5 μM of the above primers set, 3 mM MgCl₂, and 2.5 U of Taq DNA polymerase. A colony of Salmonella grown overnight in TSAYE was suspended in 0.5 ml of DNA grade water (Fisher Scientific, Pittsburgh, Pa.) containing 5 mM of NaOH and boiled for ten minutes to rupture the cells. Alternately, 0.1 ml of an overnight Salmonella culture grown in TSBYE was mixed with 0.4 ml of distilled DNA grade water containing 5 mM of NaOH and boiled for ten minutes. As a template, 1 μl was added to the PCR reaction mixture. The cycling reaction was performed as follows: heat denature at 94° C. for five minutes with additional 30 cycles of heat denature at 94° C. for thirty seconds, primer annealing at 59° C. for thirty seconds, and extension at 72° C. for forty-five seconds. After the final cycle, the samples were maintained at 72° C. for ten minutes to complete the DNA strands synthesis and then cooled to 4° C., unless used immediately.

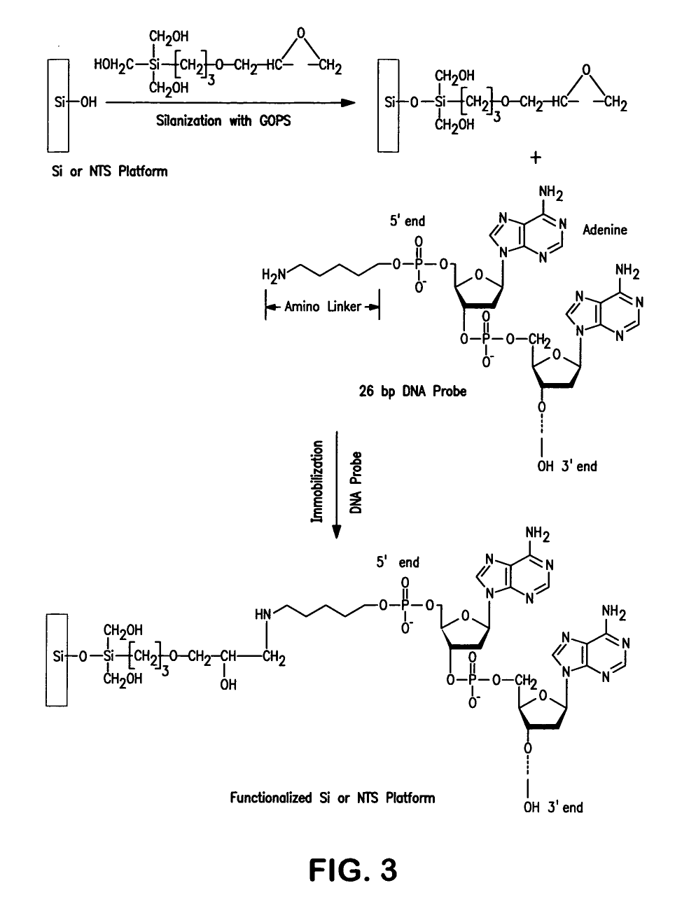

Silanization of nano-tubular Si platform: FIG. 3 illustrates the functionalization of the nano-tubular silicon (Si) platform into a DNA biosensor, comprising two main steps: (1) silanization; and (2) DNA oligonucleotide probe immobilization. For silanization, the nano-tubular Si substrates were first cleaned in boiling acetone for five minutes, boiling methanol for five minutes, and then dried with nitrogen. The substrates were immersed in sulfochromic acid, as a strong oxidizing agent, for fifteen minutes. This hydrated the surface and prepared it for silanization. Following the acid treatment, the substrates were washed twice in deionized water and dried under nitrogen flow. The substrates were then placed in a clean oven for one hour at 140° C. Immediately after heating, the substrates were transferred to a glove box under dry nitrogen atmosphere. A 10% 3-glycidoxypropyl-trimethoxysilane (GOPS) solution, in dry toluene, was placed on the substrates. The substrates were left to react under nitrogen for four hours, then rinsed with toluene and left to dry. A background electrochemical cyclic voltammetry (CV) reading was then taken prior to DNA probe immobilization.

DNA probe immobilization: Immobilization of the probe layer was performed by coating each substrate with fifty microliters (50 μl) of 150 nM aqueous solution DNA probe (in 1 mM NaOH) specific to the pathogen of interest, and leaving them to react overnight at room temperature in the glove box. The substrates were finally placed in boiling water for two minutes to remove excess unreacted DNA probe and dried with a nitrogen flow. The unreacted aldehyde groups of GOPS were then saturated by dipping the chips in a 0.1 M glycine solution for twenty minutes. Chips were washed using a washing solution (1×SSC containing NaCl and Na-citrate) and dried with a nitrogen flow. Electrochemical cyclic voltammetry (CV) reading was taken prior to target DNA hybridization. The biosensor was stored under nitrogen for maximum stability, until usage.

Characterization of the DNA: Following PCR, the size of the PCR amplified DNA product was determined using gel electrophoresis. The concentration of the DNA was also determined using Bio-Rad SmartSpec 3000 spectrophotometer (Bio-Rad Laboratories, Inc., Hercules, Calif.) readings at 260 and 280 nm wavelengths. The PCR amplified DNA was diluted to 10⁻⁹ μg/μl in hybridization buffer (5×SSC, 0.1% SDS, 0.5% BSA—see below) and used for initial characterization of the nano-tubular silicon (Si) DNA-based biosensor.

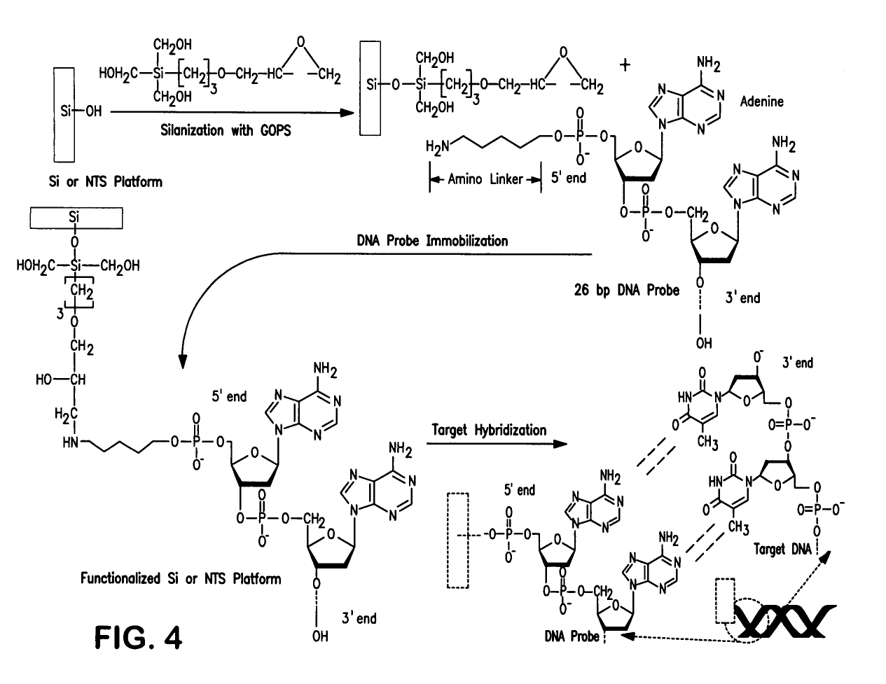

Target DNA Hybridization: The DNA in the hybridization buffer was heated to 95° C. in a water bath to separate double-stranded DNA, and cooled to 59° C., just below the melting temperature of the capture probe. The hybridization of complementary DNA strands (obtained by extracting DNA from the sample of interest) with the immobilized oligonucleotide probe layer was performed by dipping the DNA modified chip in a solution of the target DNA at the appropriate concentration in hybridization buffer for forty-five to sixty minutes (45-60 min) at 59° C., as schematically illustrated at the bottom of FIG. 4. The non-specifically adsorbed strands are thereafter removed by extensive washing in Wash solution A (0.1×SSC, 0.1% SDS) followed by Wash solution B (0.1×SSC). The chips are then dried under nitrogen and CV readings are measured. Optimum operating conditions for the biosensor were determined.

Electrochemical detection—Cyclic Voltammetry: Before adding the target DNA, a baseline was obtained for each sensor, after DNA probe immobilization, using a blank electrolyte that was an aqueous solution of 5 mM potassium ferrocyanide in 1 M potassium nitrate. A volume of twenty-five milliliters (25 ml) was added to a three-electrode electrochemical cell 210 configuration schematically illustrated in FIG. 5. As seen in FIG. 5, the three-electrode electrochemical cell 210, has a Ag/AgCl reference electrode 211 and a graphite rod counter electrode 212, with a working electrode 213 that is placed against a copper plate 214 and connected to a potentiostat/galvanostat (not shown). The electrochemical response can be measured using the potentiostat/galvanostat to generate cyclic voltammograms. The electrochemical cell 210 is sealed with a TEFLON® o-ring 215 by means of a clamp 216 against the working electrode 213 to contain the electrolyte solution 217.

Cyclic voltammetry was performed using the electrochemical cell 210 configuration of FIG. 5 with the blank electrolyte solution as the electrolyte solution 217 and using a Versastat II Potentiostat/Galvanostat (AMETEK Princeton Applied Research, Oak Ridge, Tenn.). Porous silicon as the working electrode 213 was the treated biosensor platform, the reference electrode 211 was Ag/AgCl, and the counter electrode 212 was a graphite rod. The potentiostat was run in the ramp, one vertex multi mode. The potential was cycled between −1.2 V to +1.5 V at a scan rate of 20 mV/s. The resulting current was measured and plotted against the potential. After measurement, the blank solution was discarded. The procedure was repeated with the biosensor following target DNA hybridization.

Confirmation of results: Atomic Force Microscopy images were used to determine surface level changes occurring due to immobilization of the DNA probe and the target DNA hybridization.

Statistical Analysis: For each set of experiments, the raw data consisted of plots of Current (I) vs. Potential (E) curves with data from two successive cycles (technical replicates) collected for analysis. Each cycle of the biological replicate consisted of 1020 pairs of points (E, I). Half of these points corresponded to the oxidation reaction and the other half corresponded to the reduction reaction of the cycle.

The maximum and minimum peak currents at the oxidation-reductions shifts on the cyclic voltammograms were selected for statistical analysis. Mean significant differences between the “peak current after addition of the DNA target” and “peak current before addition of the DNA target” were statistically analyzed to determine the presence or absence of the target pathogen DNA in the sample. Such an approach would involve using only one single data point from the anodic and the cathodic side of the cyclic voltammogram.

II. Determination of Sensitivity of the Nano-Tubular Silicon Biosensor in Pure Culture.

Sensitivity of the biosensor using PCR amplified DNA: An overnight culture of Salmonella, as described above, was used to assess the sensitivity, i.e. the lower detection level, of the biosensor. DNA was extracted from the overnight culture of Salmonella and PCR performed. The PCR product was diluted serially so that the concentration ranged from 10⁻⁹ μg/μl to 10⁻¹⁵ μg/μl, followed by testing each DNA concentration with the nano-tubular silicon (Si) working electrode as described previously to determine the sensitivity of the biosensor.

Sensitivity of the biosensor using DNA from pure culture: An overnight Salmonella enteritidis was used to assess the sensitivity, i.e. the lower detection level, of the nano-tubular Si biosensor. Genomic DNA was extracted from an overnight Salmonella enteritidis culture using the QiaAmp DNA Mini Kit (Qiagen Inc., Valencia, Calif.), followed by serial dilution of the genomic DNA from 10⁻⁹ μg/μl to 10⁻¹² μg/μl (and lower, if necessary) for testing with the nano-tubular Si biosensor and planar Si biosensor as described previously. The sensitivity of the biosensor was then determined. This was done to evaluate the need for PCR of the DNA target prior to detection by the biosensor.

Confirmation of results: Results from all of the above procedures were confirmed by following standard plating method (Food and Drug Administration. 2000. Bacteriological Analytical Manual. 8th ed. Arlington, Va.: Association of Analytical Chemists) and gel electrophoresis. DNA concentrations were determined using Bio-Rad SmartSpec 3000 spectrophotometer readings at 260 and 280 nm wavelengths.

Statistical Analysis: All the above trials were performed in triplicate. For each set of experiments, the raw data consisted of plots of I vs. E curves with two technical replicates used for analysis. Each cycle of the biological replicate consisted of 1020 pairs of points (E, I). Half of these points corresponded to the oxidation reaction and the other half corresponded to the reduction reaction of the cycle.

Analysis of Curves (Modeling): For each technical replicate cycle, oxidation and reduction reactions segments of the curve were analyzed separately. A generalized additive model was used to model the current as a function of voltage because these models have the flexibility of incorporating a semiparametric component (smoothing spline) to obtain a smoothed fit for two variables, especially when the functional form of the relationship is not known. PROC. GAM of SAS was used to fit these models for each condition (combination of Hybridization step, DNA Concentration, DNA Source and DNA target). The two technical replications were averaged before fitting the generalized additive model. In addition to the smoothing curve, a 95% confidence interval was calculated.

Analysis of Delta Q values: Another approach used to determine significant differences in the current signal output was to calculate the amount of charge (Q) passed during an experiment. Cumulative charge (ΔQ) values were obtained using the cyclic voltammetry PowerSUITE® electrochemical software (AMETEK Princeton Applied Research) by selecting the whole set of 1020 points. The software calculated the ΔQ as the integral of current across the selected set of points with respect to time, and displayed it in a hoover box.

The ΔQ values (one for each cycle) were collected and analyzed using ANOVA models. Values from the two cycles were analyzed individually. In a first analysis, the three hybridization conditions were compared within each combination of Concentration, DNA Source (pure or PCR). A significant ANOVA was followed by a protected LSD (least significant difference) test. Subsequently, factorial ANOVA analyses (using PROC. Mixed) were used to study the three-way interaction among Hybridization, Concentration and Source as well as the double interaction of Hybridization with Concentration. Depending on the results of these interaction tests, Single or Main effect contrasts among hybridization types were calculated. Finally, differences in performance between the two platforms, nano-tubular Si and planar Si, were also determined.

III. Determination of Specificity of the Nano-Tubular Silicon Biosensor Using Mixed Bacterial Cultures.

Specificity testing: In order to determine the specificity of the biosensor (the Salmonella DNA probes used), Salmonella cultures were mixed with related bacteria (Escherichia coli). PCR was performed using these mixed as well as non-specific bacterial cultures (only E. coli) as described. Also, genomic DNA was extracted from an overnight E. coli K-12 culture. The extracted genomic E. coli DNA was then tested with the nano-tubular Si biosensor by itself (non-target) and in a mixture containing 1:1 ratio of 1 ng/μl each of S. Enteritidis and E. coli DNA as described previously. The signal generated was compared statistically against negative and positive control samples of Salmonella Enteritidis DNA to determine the specificity of the biosensor.

Confirmation of results: Results from all of the above procedures were confirmed by gel electrophoresis and spectrophotometer readings at 260 and 280 nm wavelengths.

Statistical Analysis: All the above trials were done in triplicate. Analysis of the data was performed as described previously to determine significant differences in mean ΔQ values between and within Species (E. coli or Salmonella). SAS program was used for statistical analysis.

IV. Reagents for DNA-Based Testing.

Hybridization Buffer: Place 100 ml of the hybridization buffer supplied with the detection system in a beaker containing a magnetic stir bar. Place the beaker on a heating stir plate and rapidly stir the buffer while heating to 42 degrees Celsius (C). Quickly, add 4.38 g of NaCl and 5.0 g of blocking powder also (provided with the detection system) into the buffer. Continue to stir this mixture at 42 degrees Celsius for 1 hour. The buffer may now be aliquoted into sterile plastic tubes and stored at −20 degrees C. Prior to use, the buffer must be thawed and re-heated to 42 degrees C. for at least 30 minutes.

20×SSC: Add 175.3 g NaCl and 88.2 g NaCitrate (trisodium salt) in distilled-deionized water to a final volume of 1.0 liter. Adjust the pH of the solution to 7.0 using HCl or NaOH. This solution can be stored at room temperature without sterilization.

20% SDS (sodium lauryl [dodecyl] sulfate): Dissolve 100 g SDS in 400 ml of distilled-deionized water. The solution will be cloudy, but adjust the pH to 7.2 using HCl. Bring the final volume to 500 ml with distilled-deionized water. This solution can be stored at room temperature without sterilization. (If the solution remains cloudy or becomes cloudy in the future, warm it to 50-65 degrees Celsius to dissolve the SDS before dispensing.)

Primary Wash Buffer: To 800 ml of distilled-deionized water, add 25 ml of 20×SSC, 20 ml of 20% SDS, and 360 grams urea. Bring the final volume to 1000 ml with distilled-deionized water. This solution can be stored at room temperature without sterilization. Note: Stringency can be increased by using only 5 ml of 20× SSC instead of 25 ml. However, in our experience, this has not been found to be necessary with the IS6110 probe.

Secondary Wash Buffer: To 800 ml of distilled-deionized water, add 100 ml of 20×SSC. Bring the final volume to 1000 ml with distilled-deionized water. This solution can be stored at room temperature without sterilization.

Agarose Gel Loading Dye (6× Loading Dye): For 250 ml, add 0.63 g Bromophenol Blue, anhydrous to about 150 ml of water in a 500 ml glass beaker, stir for 60 min. Add 25 ml of 100% glycerol with a 60 cc syringe, stir until thoroughly mixed, an additional 30 min. Make up the volume to 250 ml with deionized water. Continue to stir for 30 min. Adjust to final volume of 250 ml. Aliquot 20 ml of dye into 50 ml conical tubes. Store at 4° C.

### Example 1

Nanoporous Silicon (NPS) Characterization: The porosity and thickness of the nanoporous silicon (NPS) obtained using anodization conditions of 5 mA/cm² for 1 h with 15% ethanoic solution of HF was determined gravimetrically (Table 1). The percent porosity of the NPS ranged from 70.00% (Chip 10) to 87.23% (Chip 4), and the thickness of the NPS layer varied from 13.09 μm (Chip 3) to 21.67 μm (Chip 1). The mean percent porosity of the NPS layer for the 14 chips was 80.21%±4.29% with a corresponding mean thickness of 17.54 μm±2.82 μm. The percent porosity of the NPS was similar to that reported previously under similar anodizing conditions (Amato, G., Boarino, L., Borini, S., Rossi, A. M., 2000. Hybrid approach to porous silicon integrated waveguides. Phys. Status Solidi A-Appl. Res. 182(1), 425-430; Halimaoui, A., 1997. Porous silicon formation by anodization. In: Canham, L. (Ed.), Properties of porous silicon. INSPEC, The Institution of Electrical Engineers, London, UK, pp. 12-14; Janshoff, A., Dancil, K.-P. S., Steinem, C., Greiner, D. P., Lin, V. S.-Y., Gurtner, C., Motesharei, K., Sailor, M. J., Ghadiri, M. R., 1998. Macroporous p-type silicon Fabry-Perot layers. Fabrication, characterization, and applications in biosensing. Journal of the American Chemical Society 120(46), 12108-12116). The variation in porosity and thickness observed was possibly due to batch-to-batch variations in composition of the ethanoic HF used or slight fluctuations in the current density applied to the silicon chip.

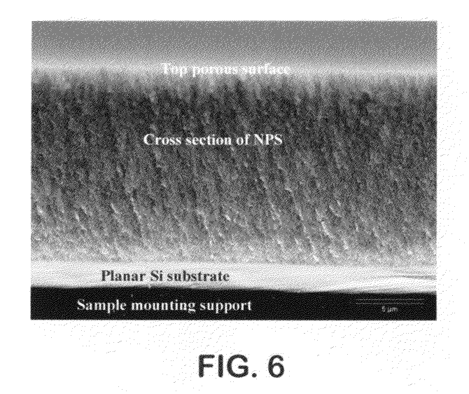

A cross-sectional SEM image was taken by carefully dicing the NPS chip with a diamond saw and mounting the cross-section of the chip at a 45° angle. The scanning electron micrograph provided additional confirmation of the thickness obtained by gravimetric analysis (FIG. 6). The micrograph shows the NPS structures to be about 15-20 μm thick/deep and interconnected to some degree.

TABLE 1
Thickness and porosity of nano-porous Si chips
fabricated from p⁺⁺ Si.

| | | | | | Thickness | Porosity |
|---|---|---|---|---|---|---|
| Chip | m₁ (g) | m₂ (g) | M₃ (g) | Area (cm²) | (μm) | (%) |
| 1 | 0.2747 | 0.2708 | 0.2699 | 0.950714 | 21.67 | 81.25 |
| 2 | 0.3365 | 0.3329 | 0.3322 | 0.950714 | 19.41 | 83.72 |
| 3 | 0.3697 | 0.3674 | 0.3668 | 0.950714 | 13.09 | 79.31 |
| 4 | 0.32 | 0.3159 | 0.3153 | 0.950714 | 21.22 | 87.23 |
| 5 | 0.345 | 0.3413 | 0.3406 | 0.950714 | 19.86 | 84.09 |
| 6 | 0.2981 | 0.2946 | 0.2938 | 0.950714 | 19.41 | 81.40 |
| 7 | 0.3369 | 0.3336 | 0.3327 | 0.950714 | 18.96 | 78.57 |
| 8 | 0.3306 | 0.328 | 0.3272 | 0.950714 | 15.35 | 76.47 |
| 9 | 0.3087 | 0.3062 | 0.3055 | 0.950714 | 14.45 | 78.12 |
| 10 | 0.3171 | 0.315 | 0.3141 | 0.950714 | 13.54 | 70.00 |
| 11 | 0.3281 | 0.3249 | 0.3242 | 0.950714 | 17.61 | 82.05 |
| 12 | 0.3523 | 0.3491 | 0.3484 | 0.950714 | 17.61 | 82.05 |
| 13 | 0.3084 | 0.3059 | 0.3051 | 0.950714 | 14.90 | 75.76 |
| 14 | 0.2673 | 0.2639 | 0.2632 | 0.950714 | 18.51 | 82.93 |

Anodizing conditions used were 15% HF, 5 mA/cm² for 1 h.

When using doped p-type silicon to produce a porous silicon-based bioreactor for glucose detection, Bengtsson et al. (Bengtsson, M., Drott, J., Laurell, T., 2000. Tailoring of porous silicon morphology in chip integrated bioreactors. Phys. Status Solidi A-Appl. Res. 182(1), 533-539) produced a porous surface with a maximum thickness of 10 μm, while DeLouise and Miller (DeLouise, L. A., Miller, B. L., 2005. Enzyme immobilization in porous silicon: Quantitative analysis of the kinetic parameters for glutathione-5-transferases. Analytical Chemistry 77(7), 1950-1956) could only obtain a 6.5 μm thick porous layer for enzyme immobilization. Other investigators have also reported similar thickness when fabricating porous silicon layers from highly doped p-type wafers (Martin-Palma, R. J., Torres-Costa, V., Arroyo-Hernandez, M., Manso, M., Perez-Rigueiro, J., Martinez-Duart, J. M., 2004. Porous silicon multilayer stacks for optical biosensing applications. Microelectronics Journal 35(1), 45-48; Splinter, A., Sturmann, J., Benecke, W., 2001. Novel porous silicon formation technology using internal current generation. Materials Science and Engineering: C 15(1-2), 109-112). Halimaoui (Halimaoui, ibid, 1997) predicted the possibility of producing a porous silicon layer 13 μm thick using 25% HF and a fixed current density of 50 mA/cm² for 4 minutes. However, a porous silicon layer with more than 10 μm thickness using highly doped p-type silicon has not been reported, especially with lower current densities. The current research has shown a significant improvement (50-100%) in the thickness of the porous layer over currently reported values, thus justifying the name NPS. This improvement was made possible by maintaining the potential, V, less than Vₑₚ, the electropolishing peak potential. As long as the current density, J<Jₑₚ, the supply of holes was restricted to maintain the H-terminated surface throughout etching (Chazalviel, J. N., Belaidi, A., Safi, M., Maroun, F., Erne, B. H., Ozanam, F., 2000. In situ semiconductor surface characterisation: a comparative infrared study of Si, Ge and GaAs. Electrochim. Acta 45(20), 3205-3211; Safi, M., Chazalviel, J. N., Cherkaoui, M., Belaidi, A., Gorochov, O., 2002. Etching of n-type silicon in (HF plus oxidant) solutions: in situ characterisation of surface chemistry. Electrochim. Acta 47(16), 2573-2581).

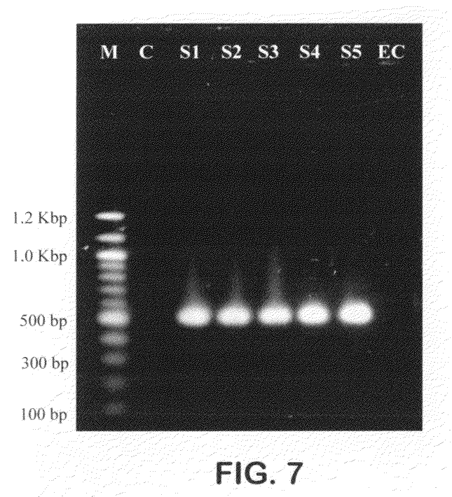

Polymerase chain reaction: A clinical strain of Salmonella Enteritidis (strain S-64, MDCH collection) was used as the target for development of the nucleic acid-based biosensor. The chosen PCR primers and the DNA capture probe were from the insertion (iel) gene of Salmonella Enteritidis with a very high degree of specificity for Salmonella species. In order to determine the specificity of the biosensor, DNA from Salmonella cultures was mixed with that of related bacteria (Escherichia coli) and tested with the NPS Salmonella biosensor. FIG. 7 shows the gel electrophoresis image of PCR amplified DNA from an overnight S. Enteritidis mixed 1:1 with generic E. coli culture, as well as non-specific bacterial cultures (only E. coli). In the lane EC, no DNA bands were observed. Hence, there was no PCR amplification of the E. coli genome, indicative of the specificity of the PCR primers used. The thickness of the PCR-amplified ‘Salmonella-E. coli mix’ DNA bands increased with the amount of culture inoculum used for PCR (1-5 μl). The DNA bands in lanes S1-S5 were observed parallel to the 500 bp band in marker lane (M). The PCR amplified DNA product should be 505 bp long (positions 542 to 1047 of the iel gene of Salmonella Enteritidis). PCR amplified DNA from a pure culture of S. Enteritidis also showed a 500 bp amplicon (data not shown).

The concentration of DNA in the PCR amplified (pooled) sample, determined using spectrophotometer measurements, was 132.61 μg/ml with an A_{260/280} ratio (purity) of 1.99, indicative of the high quality of the PCR DNA product.

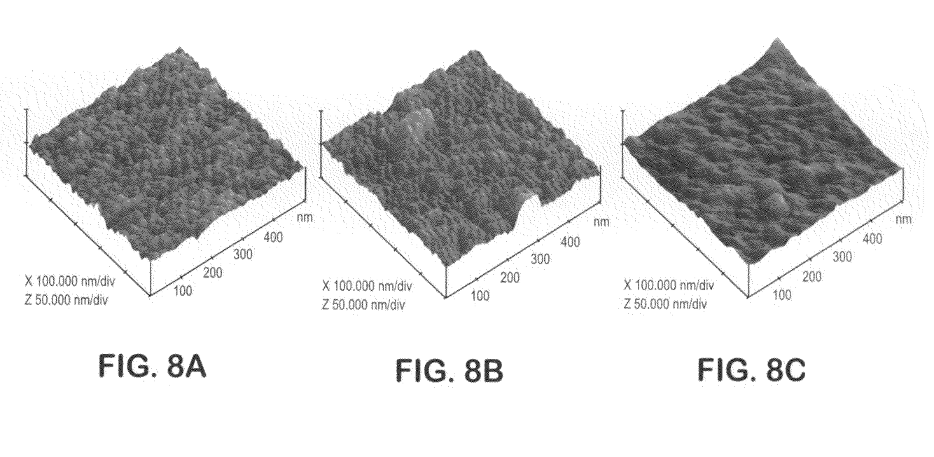

AFM characterization of NPS DNA biosensor: FIG. 8 shows the surface profiles of NPS DNA biosensor chips prior to DNA probe immobilization, after DNA probe immobilization, and following target DNA hybridization at the nanometer scale. The profile of the NPS surface prior to DNA probe immobilization (immediately after silanization) confirmed the SEM image characterization of NPS with pores distributed evenly throughout the surface (FIG. 8A). After probe immobilization, a small change in the surface profile was observed, with some surface leveling and deposition of matter in the pores and inter-pore spaces occurring on the chip surface (FIG. 8B). Following target DNA hybridization on the NPS biosensor chip (and after washing steps and drying under nitrogen gas stream), AFM showed that the surface profile changed drastically with smoothening of the surface observed at the nanometer scale, indicating extensive deposition of matter in the pores as well as on the inter-pore spaces (FIG. 8C). This is hypothesized to be from the hybridization of DNA target to the biosensor chip surface, as care was taken to prevent non-specific binding of organic matter to the biosensor surface through use of surface blocking agents (bovine serum albumin), washing steps, and a high degree of hybridization specificity by maintaining the hybridization temperature at 59° C. (melting point of capture probe was 60° C.) with a standard hybridization buffer.

Electrochemical detection of DNA using NPS biosensor: Cyclic voltammetry measures the faradaic current resulting from electron transfer. Two factors can affect the faradaic current: the rate the redox species diffuses to the electrode, and the rate of electron transfer. The rate of electron transfer for the common redox couple Fe(CN)₆^{3-/4-} is reasonably fast. The reaction at the working electrode or cathode is Fe(CN)₆³⁻+e⁻ [symbol] Fe(CN)₆⁴⁻, where one electron is added to the ferricyanide anion to reduce iron from the +3 to the +2 oxidation state. This reaction proceeds in both directions (cyclic process) so that species can be oxidized to Fe(CN)₆³⁻, then reduced back to Fe(CN)₆⁴⁻. A cyclic voltammogram (CV) is a valuable and convenient tool to monitor the barrier of the modified electrode because electron transfer between the solution species and the electrode must occur by tunneling either through the barrier or through the defects in the barrier. When an electrode surface is modified by some materials, the electron-transfer kinetics of Fe(CN)⁻⁴₆ is perturbed, in turn affecting the output current. Therefore, cyclic voltammetry was chosen as a method to investigate the changes in electrochemical behavior of the system after each step, from silanization to DNA target hybridization.

The specific DNA concentration to be tested with the biosensor was diluted to a total volume of 5 ml using the DNA hybridization buffer and then heated to 59° C. The chips to be tested were then placed in the hybridization buffer solution containing the target DNA and allowed to hybridize for 45 min. A hybridization time of 45 min was chosen for all experiments giving a total assay time of 60 min (45 min for hybridization and 15 min for the cyclic voltammetry testing procedure). After hybridization, the NPS and planar Si chips were subjected to cyclic voltammetry for the final time.

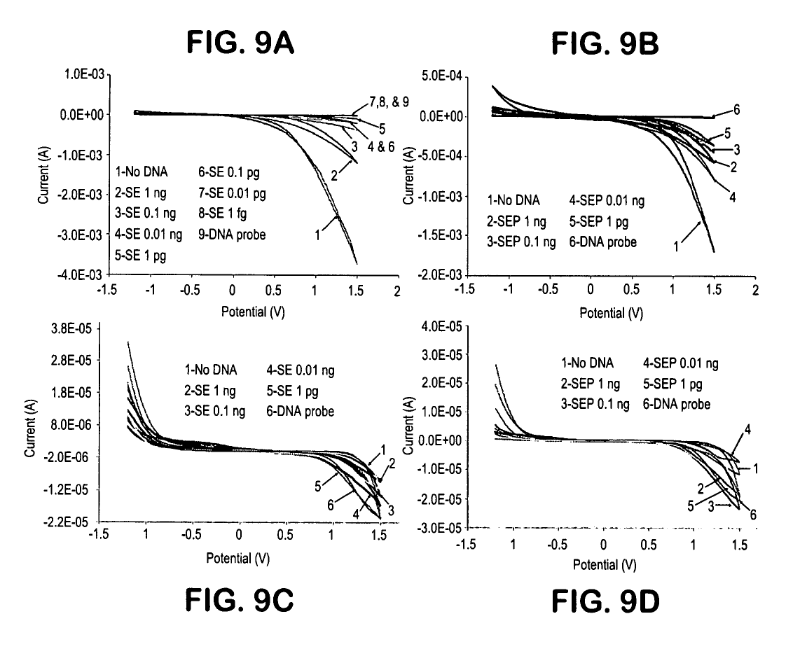

FIG. 9 illustrates the CV obtained for PCR-amplified DNA and isolated S. Enteritidis genomic DNA with the NPS biosensor as well as planar Si biosensor using 5 mM potassium ferrocyanide as the redox couple marker in 1 M potassium nitrate after different processing steps. For the sake of clarity of the cyclic voltammograms (CVs), the standard errors of the curves are not shown. Moreover, for ease of comparison, the CVs for 1 ng/μl biosensor chips obtained prior to DNA immobilization (Line 1—No DNA) and after DNA probe immobilization (Line 9 or Line 6—DNA probe) are the only ones included along with the CVs for each DNA concentration after the target DNA hybridization. The CVs did not have a characteristic cathodic (I_{pc}) or anodic peak current (Iₚₐ) observed (Shippy, S., Burns, R., 2002. Cyclic voltammetry: An example of voltaic methods), thus showing signs of irreversibility of reactions. The current went to a steady-state maximum on the cathodic side and was not peak-shaped.

When the rate of electron transfer is sufficiently slow so that the potential no longer reflects the equilibrium activity of the redox couple (Fe(CN)₆³⁻+e [symbol] Fe(CN)₆⁴⁻) at the working electrode surface, the reaction is considered irreversible. In such a case, the potentials corresponding to the cathodic and anodic current peaks (Eₚ) would change as a function of the scan rate. This steady-state current could be explained by envisioning the working electrode (NPS biosensor) placed at the bottom of the 3-electrode electrochemical cell as a “dot”, with the diffusion boundary layer being hemispherical in shape extending up into the solution. The amount of ferrocene diffusing to the working electrode surface would be defined by the volume enclosed by the hemisphere, which is much smaller than a plane projecting into the solution as in the case of a planar electrode immersed completely into the electrochemical cell (Wang, J., 2000. Analytical Electrochemistry, 2nd ed. Wiley-VCH, New York, N.Y.). The atypical CV response could thus be explained by the limited area available for the diffusion layer at the bottom of the cell for electron transfer combined with the use of silicon as the working electrode (lower conductivity) instead of platinum that is used to generate typical CV curves.

Without any DNA deposited on the NPS surface, the resistance or barrier offered to the flow of electrons was the least, resulting in a CV with a high current output (Line 1 in FIG. 9A and FIG. 9B). The output current for PCR DNA cycled between 10 μA on the cathodic side to about −4 mA on the anodic side, while that for genomic DNA cycled between 10 μA to −1 mA. After immobilization of the single-stranded DNA capture probe, the current drastically decreased on the anodic side (Line 9 in FIG. 9A and Line 6 in FIG. 9B) and was significantly lower (as determined statistically below) than that prior to probe immobilization, with the current output cycling from 1 μA to −1 μA. After hybridization of the complementary DNA target, the obtained CV showed relatively higher current values on the anodic side (FIG. 9A and FIG. 9B) when compared to the chip with the immobilized DNA probe only. The extent of change in the anodic current from that of the DNA probe chip was related to the amount of target PCR or genomic DNA getting hybridized to the NPS biosensor chip. The highest change in anodic current for PCR-amplified DNA and genomic DNA was observed for 1 ng/μl DNA (FIG. 9A) and 0.01 ng/μl DNA (FIG. 9B) concentrations, and the lowest change observed for 1 fg/μl (FIG. 9A) and 1 μg/μl (FIG. 9B), respectively.

Immobilization of the single-stranded DNA would form an insulating diffusion barrier on the working electrode surface, hindering electron transfer through the working electrode. This insulating phenomenon was similar to that observed in previous studies that employed physical parameters (besides the conductivity of the working electrode or reporting molecules employed) for direct label-free electrochemical detection of specific DNA sequences. For example, Souteyrand et al. (Souteyrand, E., Cloarec, J. P., Martin, J. R., Wilson, C., Lawrence, I., Mikkelsen, S., Lawrence, M. F., 1997. Direct detection of the hybridization of synthetic homo-oligomer DNA sequences by field effect. J. Phys. Chem. B 101(15), 2980-2985) used a probe-coated field-effect silicon device for in situ impedance measurements of DNA sequences. The device displayed well-defined shifts of the impedance curves, corresponding to changes in surface charge induced by base-pair recognition. Similarly, Berggren et al. (Berggren, C., Stalhandske, P., Brundell, J., Johansson, G., 1999. A feasibility study of a capacitive biosensor for direct detection of DNA hybridization. Electroanalysis 11(3), 156-160) demonstrated a positive change in the capacitance of a thiolated (insulating) oligonucleotide modified gold electrode caused by hybridization of the complementary DNA strand (and the corresponding displacement of solvent molecules from the surface). An even greater insulating property of a single-stranded DNA monolayer on the gold electrode was observed in a previous study by the same authors (Berggren, C., Johansson, G., 1997. Capacitance measurements of antibody-antigen interactions in a flow system. Anal. Chem. 69(18), 3651-3657).

The intrinsic electroactivity of DNA (Palecek, E., 1996. From polarography of DNA to microanalysis with nucleic acid-modified electrodes. Electroanalysis 8(1), 7-14) restores the anodic current upon hybridization of the target DNA. Of the four nucleobases, guanine and adenine are readily oxidized. The decreased guanine and adenine response of the immobilized oligonucleotide probe restored upon hybridization of the complementary strand has been used for detecting RNA hybridization (Wang, J., Cai, X. H., Wang, J. Y., Jonsson, C., Palecek, E., 1995. Trace measurements of RNA by potentiometric stripping analysis at carbon-paste electrodes. Anal. Chem. 67(22), 4065-4070). Other studies have also demonstrated a similar increase in signal with hybridization of the target DNA strand with and without reporting molecules such as Hoechst 33258 or [Ru(bpy)₃]³⁺ (Kobayashi, M., Takashi, K. B., Saito, M., Kaji, S., Oomura, M., Iwabuchi, S., Morita, Y., Hasan, Q., Tamiya, E., 2004. Electrochemical DNA quantification based on aggregation induced by Hoechst 33258. Electrochem. Commun. 6(4), 337-343; Lee, H. Y., Park, J. W., Jung, H. S., Kim, J. M., Kawai, T., 2004. Electrochemical assay of nonlabeled DNA chip and SNOM imaging by using streptavidin-biotin interaction. J. Nanosci. Nanotechnol. 4(7), 882-885; Li, J. H., Hu, J. B., 2004. Functional gold nanoparticle-enhanced electrochemical determination of DNA hybridization and sequence-speciric analysis. Acta Chim. Sin. 62(20), 2081-2088; Wang, J., 1999. Towards genoelectronics: Electrochemical biosensing of DNA hybridization. Chem.-Eur. J. 5(6), 1681-1685).

When planar Si biosensor chips were tested with different PCR-amplified and genomic Salmonella DNA concentrations, the anodic current for the CV before DNA probe immobilization (Line 1—No DNA) was two orders of magnitude lower than that obtained with NPS biosensor chip (FIG. 9B and FIG. 9D). The output current cycled between 1 μA on the cathodic side to about −10 μA on the anodic side for PCR DNA, while that for genomic DNA cycled between 25 μA to −20 μA. For both, PCR and genomic DNA, the CV for the planar Si biosensor chip after DNA probe immobilization (Line 6) and that after the target DNA hybridization were all in the same range, with the current output cycling from about 4 μA to −22 μA. In contrast to the CVs obtained for the NPS biosensor chips, no specific patterns of interest could be observed for the planar Si chips. Based on FIG. 9A-B and FIG. 9C-D, there appears to be a significant difference in the performance of the NPS and planar Si biosensors (to be confirmed by statistical analysis).

Data Analysis of Delta Q values: Delta Q is the integral of current across the selected set of points with respect to time. Thus, ΔQ takes into account all the data points in the curve in order to generate one representative cumulative charge value for each CV curve, making the methodology better than peak analysis that considers a single peak point (anodic and/or cathodic current). Moreover, when calculating the integral charge value, the time factor was also used along with the voltage, incorporating any effects of the time factor into the model automatically. The calculation of the Delta Q did not affect the original curve data values, thus providing a measure suitable for comparison under various experimental conditions.

Table 2 provide results of ANOVA performed on the ΔQ values for PCR-amplified S. Enteritidis DNA and isolated S. Enteritidis genomic DNA, respectively, of the CVs obtained for various DNA concentrations using the NPS biosensor as well as the planar Si biosensor. The standard errors provided in the Tables are common to each experimental group. One of the assumptions of ANOVA was homogeneity of variances to increase the power of the analysis.

The ‘Blank’ ΔQ values prior to DNA probe immobilization and ΔQ values ‘Before’ target DNA hybridization on the NPS biosensor chips varied greatly from −14 to −148 mC and −947 to 339 μC, respectively (Table 2). However, this variation did not affect the biosensor performance as the focus of the assay was the mean difference between ΔQ values for the ‘Before’ and the ‘After’ target DNA hybridization steps. The ΔQ values for CVs corresponding to those ‘After’ PCR-amplified DNA target hybridization decreased in magnitude with a decrease in DNA concentration. For example, the mean ΔQ values for CVs corresponding to 1 ng, 0.1 ng and 0.01 ng of DNA were −45.767±3.72, −14.467±2.33, and −12.633±1.79 mC, respectively. The ΔQ values for CVs corresponding to those ‘After’ genomic DNA target hybridization increased in magnitude compared to that ‘Before’ target hybridization. For example, the mean ΔQ values for CVs corresponding to 1 ng and 0.01 ng—‘Before’ were −0.028±0.81, and 0.008±4.63 mC, while ‘After’ were −75.700±0.81, and −26.633±4.63 mC, respectively (Table 2). However, unlike for PCR-amplified DNA, no particular trend was observed for the increase in ΔQ values for ‘After’ genomic DNA hybridization, possibly due to random hybridization of the genomic DNA with each other.

TABLE 2
Integral charge (ΔQ, milli coulombs) values for PCR-amplified S. Enteritidis DNA and
isolated S. Enteritidis genomic DNA with NPS biosensor and planar Si biosensor at various DNA
concentrations.

| | NPS Biosensor: DNA Hybridization Conditions | | | Planar Si Biosensor: DNA Hybridization Conditions | | |
|---|---|---|---|---|---|---|
| Concn. | Blank, ΔQ (mC) | Before, ΔQ (mC) | After, ΔQ (mC) | Blank, ΔQ (mC) | Before, ΔQ (mC) | After, ΔQ (mC) |

PCR-amplified S. Enteritidis DNA:

| | | | | | | | |
|---|---|---|---|---|---|---|---|
| 1 | ng | −148.000 ± 2.70^{c} | −0.202 ± 2.70^{a} | −39.667 ± 2.70^{b} | −0.197 ± 0.13^{a} | 0.132 ± 0.13^{a} | −0.014 ± 0.13^{a} |
| 0.1 | ng | −56.833 ± 1.24^{c} | −0.249 ± 1.24^{a} | −13.733 ± 1.24^{b} | −0.167 ± 0.11^{a} | −0.037 ± 0.11^{a} | −0.027 ± 0.11^{a} |
| 0.01 | ng | −25.000 ± 2.49^{c} | −0.174 ± 2.49^{a} | −9.797 ± 2.49^{b} | 0.094 ± 0.10^{a} | 0.090 ± 0.10^{a} | −0.021 ± 0.10^{a} |
| 1 | pg | −51.100 ± 1.15^{c} | −0.153 ± 1.15^{b} | −6.267 ± 1.15^{b} | 0.038 ± 0.11^{a} | 0.022 ± 0.11^{a} | 0.069 ± 0.11^{a} |
| 0.1 | pg | −24.133 ± 1.94^{b} | −0.210 ± 1.94^{a} | −4.770 ± 1.94^{a} | | | |
| 0.01 | pg | −49.000 ± 6.17^{b} | −0.349 ± 6.17^{a} | −0.066 ± 6.17^{a} | | | |
| 1 | fg | −14.267 ± 1.55^{b} | −0.192 ± 1.55^{a} | −0.040 ± 1.55^{a} | | | |

Isolated S. Enteritidis Genomic DNA:

| | | | | | | | |
|---|---|---|---|---|---|---|---|
| 1 | ng | −30.633 ± 0.81^{b} | −0.028 ± 0.81^{a} | −75.700 ± 0.81^{c} | 0.085 ± 0.09^{a} | −0.088 ± 0.09^{ab} | −0.414 ± 0.09^{b} |
| 0.1 | ng | −66.733 ± 0.66^{c} | 0.339 ± 0.66^{a} | −10.113 ± 0.66^{b} | −0.307 ± 0.16^{a} | 0.080 ± 0.16^{a} | −0.330 ± 0.16^{a} |
| 0.01 | ng | −29.500 ± 4.63^{b} | 0.008 ± 4.63^{a} | −26.633 ± 4.63^{b} | −0.298 ± 0.12^{a} | −0.081 ± 0.12^{a} | −0.212 ± 0.12^{a} |
| 1 | pg | −105.133 ± 56.41^{a} | −0.947 ± 56.41^{a} | −25.877 ± 56.41^{a} | −0.113 ± 0.11^{a} | −0.117 ± 0.11^{a} | −0.502 ± 0.11^{a} |

Different superscripts for means across the row indicate significantly different charge values (p < 0.05)

The NPS biosensor chips could detect PCR-amplified S. Enteritidis DNA in the dynamic detection range of 1 ng to 1 pg, resulting in a sensitivity of 1 pg for the NPS biosensor chips. The sensitivity for NPS was similar to that established in previous studies using modified gold surfaces as the biosensor platform in combination with various reporting molecules (Fu, Y. Z., Yuan, R., Xu, L., Chai, Y. Q., Liu, Y., Tang, D. P., Zhang, Y., 2005. Electrochemical impedance behavior of DNA biosensor based on colloidal Ag and bilayer two-dimensional sol-gel as matrices. J. Biochem. Biophys. Methods 62(2), 163-174; Li and Hu, ibid, 2004; Wang, J., Cai, X. H., Tian, B. M., Shiraishi, H., 1996. Microfabricated thick-film electrochemical sensor for nucleic acid determination. Analyst 121(7), 965-969). With isolated S. Enteritidis genomic DNA, the NPS biosensor chips could detect in the dynamic detection range of 1 ng to 0.01 ng. Thus, the sensitivity for NPS biosensor chips with genomic DNA was 0.01 ng. This difference in the dynamic range of detection and sensitivity between PCR amplified and pure-culture genomic DNA could be due to the non-uniform DNA product (in terms of strand length) hybridizing to the DNA probe immobilized on the surface. Since the presence of guanine and adenine moieties in double-stranded DNA increases the anodic current, possible hybridization of spatially adjacent strands to each other (after hybridization of the small fragment of the iel gene to the capture probe) could lead to increased current output. The variability in AQ values is also much higher for pure culture Salmonella DNA as compared to PCR-amplified Salmonella DNA that are very uniform in size. Hence, the sensitivity for NPS with pure culture DNA was one order of magnitude lower than PCR-amplified DNA.

Sensitivity analysis of the planar Si showed that the biosensor chip was unable to detect the PCR-amplified or genomic DNA target even at 1 ng level (Table 2). There was no significant difference in ΔQ values for the “Before” and “After” hybridization steps at any DNA concentration level. The low current outputs for planar Si biosensor chips make planar Si more susceptible to variations in the data from replicate to replicate (biological or technical). The significantly higher surface area of the NPS biosensor compared to the planar Si biosensor would provide greater area for the DNA hybridization and subsequent electrochemical reaction kinetics to take place, thus explaining the difference in performance trends.

Specificity Testing: For specificity testing, isolated E. coli genomic DNA as well as the mixture of Salmonella and E. coli DNA was allowed to hybridize with the NPS biosensor. The signal generated was compared statistically against negative and positive control samples of Salmonella Enteritidis DNA to determine the specificity of the biosensor.

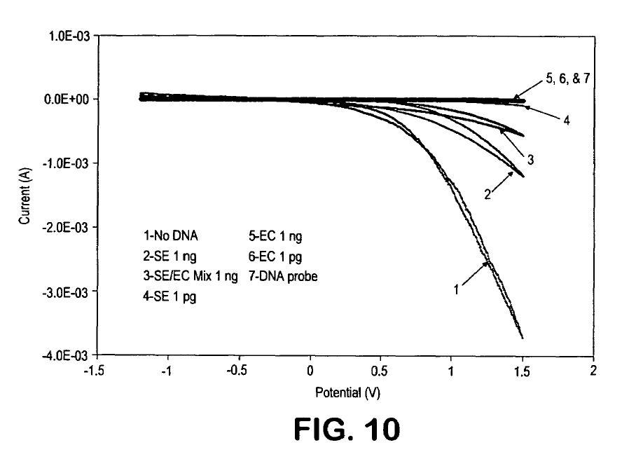

Cyclic Voltammograms: FIG. 10 shows the CVs for the NPS biosensor chips tested with E. coli genomic DNA at 1 ng/μl and 1 pg/μl concentrations as well as a 1:1 mixture of E. coli:S. Enteritidis DNA at 1 ng/μl compared against the CVs for 1 ng/μl and 1 pg/μl PCR DNA of S. Enteritidis. The anodic current for the CV before DNA probe immobilization (Line 1) was the highest of all the samples tested with the NPS biosensor platform. The CV for the NPS biosensor chip after DNA probe immobilization (Line 6) was significantly lower (as with all previous experiments) than the CV prior to probe immobilization. The anodic current did not increase after ‘hybridization’ of the non-target E. coli DNA at both levels were tested (Lines 5 and 6), as it did with Salmonella DNA (Line 2 and 4), because there was no hybridization of a complementary DNA to the NPS biosensor chip. However, when a 1:1 mixture of 1 ng/μl solution of Salmonella and E. coli DNA was tested, an increase in the magnitude of the anodic current from that of the DNA probe chip was observed (Line 3). Thus, even in the presence of non-target DNA, hybridization of complementary S. Enteritidis DNA strands occurred, and the NPS biosensor detected the hybridization event successfully.

Analysis of Delta Q values: Delta Q values for CVs of genomic E. coli DNA as well as the E. coli-S. Enteritidis mixture at DNA concentrations tested using the NPS biosensor chip are compared with those for the S. Enteritidis DNA in Table 3. For genomic E. coli DNA (1 ng/μl and 1 pg/μl), no significant increase was observed in AQ values corresponding to those ‘After’ DNA hybridization over those ‘Before’ DNA hybridization. For the Salmonella-E. coli DNA mixture, the AQ values for CVs corresponding to those ‘After’ DNA target hybridization increased significantly in magnitude over those ‘Before’ target hybridization (p<0.05). This change in AQ values for Salmonella-E. coli DNA was similar to that observed earlier with PCR-amplified and genomic S. Enteritidis DNA (Table 3).

TABLE 3
Integral charge (ΔQ, milli coulombs) values for S.
Enteritidis DNA, E. coli DNA, and S. Enteritidis-E. coli
mixture DNA with NPS biosensor.

| Concen- | DNA Hybridization Condition | | |
|---|---|---|---|
| tration | Blank, ΔQ (mC) | Before, ΔQ (mC) | After, ΔQ (mC) |
| E. coli 1 ng | −102.667 ± 13.92^{d} | −0.261 ± 13.92^{a} | −0.083 ± 13.92^{a} |
| E. coli 1 pg | −76.433 ± 13.94^{d} | −0.048 ± 13.94^{a} | −0.046 ± 13.94^{a} |
| PCR SE 1 ng | −173.333 ± 3.72^{e} | −0.231 ± 3.72^{a} | −45.767 ± 3.72^{c} |
| Genomic SE | −30.633 ± 0.81^{b} | −0.028 ± 0.81^{a} | −75.700 ± 0.81^{d} |
| 1 ng | | | |
| EC/SE mix | −52.800 ± 1.25^{c} | −0.456 ± 1.25^{a} | −43.467 ± 1.25^{c} |
| 1 ng | | | |

Different superscripts for means indicate significantly different integral charge values (p < 0.05).

The NPS biosensor could thus detect S. Enteritidis genomic DNA even in the presence of non-target E. coli DNA at an equally high concentration in the sample. The biosensor was also highly specific to the target, both with the PCR amplification as well as biosensor detection.

The NPS biosensor could potentially be used with environmental samples that normally have a high load of background DNA and other organic matter that could interfere with the biosensor performance. However, this would require fabrication of the NPS sensor platform with highly consistent pore characteristics (diameter and thickness). Current results of the DNA-based NPS biosensor show high degree of variability in performance. These differences could be caused by variability in chip characteristics, source of DNA, and sample matrix being tested. For example, ΔQ values obtained with 1 ng of PCR-amplified and genomic Salmonella DNA as well as that for 1 ng of Salmonella-E. coli DNA were significantly different from each other (Table 3). The high variability in output data is a barrier that will need to be overcome for successful development of a commercial DNA-based NPS biosensor.

Thus, nano-porous silicon was fabricated successfully. Functionalization of the NPS chip into a biosensor was achieved using silanization and immobilization of the DNA oligonucleotide probe. The NPS biosensor was able to detect 1-10 pg/μl of PCR-amplified and genomic S. Enteritidis DNA using the intrinsic properties of nucleic acids. The total assay time was 60 min. The planar Si sensor was unable to detect S. Enteritidis DNA even at 1 ng/μl concentration, proving the significant effect of the increased surface area of the NPS biosensor. The NPS biosensor was also highly specific to S. Enteritidis with no hybridization observed for E. coli DNA. Future research will involve improving the consistency in sensor performance, an important step toward commercialization of the sensor technology.

### Example 2

It is to be understood that the biosensor device of the present invention can be used to specifically detect any target nucleic acid of interest. U.S. Pat. Nos. 5,527,669 and 5,580,718 to Resnick et al.; 5,919,638 to Russell et al.; 6,277,968 to Sun et al.; 6,518,416, 6,573,052 and 6,582,919 to Danenberg; 6,881,537 to Goudsmit et al.; 6,949,342 to Golub et al.; 7,078,516 to Moncany et al.; 7,108,969 to Warrington et al.; 7,115,364 to Chee et al., are each hereby incorporated herein by reference in their entirety. These patents disclose some examples of nucleic acids, such as oligonucleotides, that can be used as the DNA probe in the present invention. The DNA probe can be designed so that it hybridizes to any known target nucleic acid of interest. In some embodiments, the sensitivity of detection of a DNA molecule or RNA molecule can be further increased by first performing a polymerase chain reaction (PCR) procedure in the case of a DNA molecule, or a reverse-transcription polymerase chain reaction (rtPCR) procedure in the case of an RNA molecule to provide an amplified product prior to detection by the biosensor device. PCR and rtPCR are methods well known to one skilled in the art. After performing the PCR or rtPCR procedures, the biosensor device is used to specifically detect the target nucleic acid of interest in the amplified product.

One example is a method of detection of HIV-1, HIV-2 or SIV virus is performed by a procedure modified from U.S. Pat. No. 7,078,516 to Moncany et al. The primers described by Moncany et al. are first used to perform a PCR reaction to provide the amplified product using a sample obtained from a human or monkey patient. Next, a biosensor device of the present invention, having a DNA probe having a nucleotide sequence of another oligonucleotide described by Moncany et al., can be used to quickly check the specificity of the amplification band. Detection by the biosensor device of the target nucleic acid of interest can be used by a physician or veterinarian to make a diagnosis of infection by the HIV-1, HIV-2 or SIV virus.

### Example 3

Another embodiment is a method of detection of hepatitis C virus (HCV) is performed by a procedure modified from U.S. Pat. Nos. 5,527,669 and 5,580,718 to Resnick et al. A sample obtained from a human patient is first used to perform a reverse transcription reaction to provide a cDNA that is used in a PCR procedure to provide an amplified product. Next, a biosensor device of the present invention, having a DNA probe having a nucleotide sequence of an oligonucleotide described by Resnick et al., can be used to quickly check the specificity of the amplification band. Detection by the biosensor device of the target nucleic acid of interest can be used by a physician to make a diagnosis of infection by the HCV virus.

### Example 4

A third embodiment is a method of detection of a bladder cancer performed by a procedure modified from U.S. Pat. No. 6,277,968, to Sun et al. The primers specific for human uroplakin II as disclosed by Sun et al. are used to perform an rtPCR procedure on a sample of total RNA extracted from human blood or tissue. Next, a biosensor device of the present invention, having a DNA probe having a nucleotide sequence of another oligonucleotide described by Moncany et al., can be used to quickly check the specificity of the amplification band. Detection by the biosensor device of the target nucleic acid of interest can be used by a physician to make a diagnosis of bladder cancer.

### Example 5

A fourth embodiment is a method of detection of a prostate cancer performed by a procedure modified from U.S. Pat. No. 5,919,638 to Russell et al. The primers specific for the products of a prostate tumor gene as disclosed by Russell et al. are used to perform an rtPCR procedure on a sample of total RNA extracted from human body fluids or tissues. Next, a biosensor device of the present invention, having a DNA probe having a nucleotide sequence of an oligonucleotide primer described by Russell et al., can be used to quickly check the specificity of the amplification band. Detection by the biosensor device of the target nucleic acid of interest can be used by a physician to make a diagnosis of prostate cancer.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the Claims attached herein.

We claim:

1. A biosensor device for detecting the presence of a target nucleic acid in a sample comprising:
(a) a porous silicon material;
(b) a single-stranded DNA probe covalently attached to the porous silicon material, wherein the probe comprises a DNA sequence complementary to a sequence of the target nucleic acid; and
(c) an electrochemical apparatus supporting the porous silicon material for detecting the presence or absence of any target nucleic acid bound to the DNA probe that is covalently attached to the porous silicon material by measuring conductance.

2. The biosensor device of claim 1., wherein the electrochemical apparatus is a potentiostat/galvanostat.

3. The biosensor device of claim 1, wherein the electrochemical apparatus measures capacitance or resistance to determine the conductance.

4. The biosensor device of claim 1, wherein the target nucleic acid is a DNA molecule.

5. The biosensor device of claim 4, wherein the target nucleic acid is a DNA molecule from a microorganism or a virus.

6. The biosensor device of claim 5, wherein the microorganism is selected from the group consisting of Salmonella, Listeria, Campylobacter, Escherichia coli O157:H7, Staphylococcus aureus, and Clostridium perfringens.

7. The biosensor device of claim 4, wherein the target nucleic acid is a DNA molecule from a eukaryote selected from the group consisting of protists, plants, fungi, and animals.

8. The biosensor device of claim 4, wherein the target nucleic acid is a DNA molecule from a human.

9. The biosensor device of claim 1, wherein the target nucleic acid is an RNA molecule.

10. A method for detecting a target nucleic acid in a sample comprising:
(a) providing the sample;
(b) providing a biosensor device for detecting the presence of the target nucleic acid in the sample comprising a porous silicon material, a single-stranded DNA probe covalently attached to the porous silicon material, wherein the probe comprises a DNA sequence complementary to a sequence of the target nucleic acid, and an electrochemical apparatus supporting the porous silicon material for detecting the presence or absence of any target nucleic acid bound to the DNA probe covalently attached to the porous silicon material by measuring conductance;
(c) contacting the porous silicon material to a solution comprising the sample under conditions such that the target nucleic acid, if present, binds to the DNA probe to provide a binding pair on the porous silicon material;
(d) inserting the porous silicon material with or without the target nucleic acid into the electrochemical apparatus for detecting the presence or absence of the target nucleic acid by measuring conductance; and
(e) detecting the presence or absence of the target nucleic acid by measuring conductance in the apparatus.

11. The method of claim 10, wherein the electrochemical apparatus is a potentiostat/galvanostat and the target nucleic acid is detected by means of cyclic voltammetry.

12. The method of claim 10, wherein the sample is from a patient and the target nucleic acid is a cancer diagnostic gene, further comprising the step of (f) diagnosing whether the patient has a cancer after detecting the presence or absence of the target nucleic acid in step (e).

13. The method of claim 10, wherein the sample is from a patient and the target nucleic acid is a DNA molecule from a microorganism or virus, further comprising the step of (f) diagnosing whether the patient is infected with the microorganism or virus after detecting the presence or absence of the target nucleic acid in step (e).

14. The method of claim 12 or 13, wherein the patient is a human.

15. The method of claim 10, wherein the target nucleic acid is a DNA molecule from a microorganism or virus, further comprising the step of (f) determining whether a location from which the sample is taken is contaminated with the microorganism or virus after detecting the presence or absence of the target nucleic acid in step (e).

16. A method for detecting a target nucleic acid in a sample comprising:
(a) providing the sample;
(b) providing a biosensor device for detecting the presence of the target nucleic acid in the sample comprising a porous silicon material, a single-stranded DNA probe covalently attached to the porous silicon material, wherein the probe comprises a DNA sequence complementary to a sequence of the target nucleic acid, and an electrochemical apparatus supporting the porous silicon material for detecting the presence or absence of any target nucleic acid bound to the DNA probe covalently attached to the porous silicon material by measuring conductance;
(c) contacting the porous silicon material to a solution comprising the sample under conditions such that the target nucleic acid, if present, binds to the DNA probe to provide a hybridized binding pair on the porous silicon material;
(d) inserting the porous silicon material with or without the target nucleic acid into the electrochemical apparatus for detecting the presence or absence of the target nucleic acid by measuring a cumulative charge value (ΔQ); and
(e) detecting the presence or absence of the target nucleic acid by measuring the cumulative charge value (ΔQ) in the apparatus.

17. The method of claim 16, wherein the sample is from a patient and the target nucleic acid is a cancer diagnostic gene, further comprising the step of (f) diagnosing whether the patient has a cancer after detecting the presence or absence of the target nucleic acid in step (e).

18. The method of claim 16, wherein the sample is from a patient and the target nucleic acid is a DNA molecule from a microorganism or virus, further comprising the step of (f) diagnosing whether the patient is infected with the microorganism or virus after detecting the presence or absence of the target nucleic acid in step (e).

19. The method of claim 17 or 18, wherein the patient is a human.

20. The method of claim 16, wherein the target nucleic acid is a DNA molecule from a microorganism or virus, further comprising the step of (f) determining whether a location from which the sample is taken is contaminated with the microorganism or virus after detecting the presence or absence of the target nucleic acid in step (e).


SEQUENCE LISTING (3 sequences)

SEQ ID NO: 1 - DNA, 24 bp, Artificial Sequence
  Synthetic primer
ctaacaggcgcatacgatctgaca

SEQ ID NO: 2 - DNA, 24 bp, Artificial Sequence
  Synethetic primer
tacgcatagcgatctccttcgttg

SEQ ID NO: 3 - DNA, 26 bp, Artificial Sequence
  Synthetic oligonucleotide
aatatgctgcctactgccctacgctt